(19) United States
(12) Patent Application Publication
(10) Pub. No.: US 2003/0113447 A1
(43) Pub. Date: Jun. 19, 2003

(54) Process and compositions for making ceramic articles

(76) Inventors: Walter J. Sherwood, Troy, NY (US); Casey E. Voorhees, Rensselaer, NY (US)

Correspondence Address: JAMES MAGEE, JR., 30 CANTERBURY RD., CLIFTON PARK, NY, 12065, US

(21) Appl. No.: 10/316,472

(22) Filed: Dec. 11, 2002

Related U.S. Application Data
(60) Provisional application No. 60/339,664, filed on Dec. 13, 2001.

(51) Int. Cl. B05D 7/00

(52) U.S. Cl. 427/221

(57) ABSTRACT

The use of ceramic forming polymers to provide non-fugitive, high purity binders for densifying and sintering ceramic materials. The polymers have a backbone of silicon linked to carbon with primarily hydrogen side-groups. The advantages of the invention include dramatically strengthening the component during the pre-sintering heating.

This invention relates to the use of ceramic precursor polymers and ceramic powders to form hard high density ceramic bodies and more particularly to the use of high ceramic yield, hydrogen containing ceramic forming polymers as vehicles and nonfugitive binders to improve densification of ceramic bodies and articles and to compositions comprising fine ceramic powders suspended in a ceramic precursor polymer and the use of such compositions to bond large ceramic particles or coat fibers and infiltrate fiber structures. The process includes the uses of a range of high purity ceramic forming polymers to improve densification of ceramic materials. The high ceramic yield, hydrogen containing ceramic forming polymers are used as nonfugitive binders to improve densification of ceramic powders, particles, and fiber structures. The invention provides the ability to optimize densification.

### BACKGROUND OF THE INVENTION

Monolithic ceramics are typically formed by compacting powders that have been coated with sintering aids by spray-drying. The powders are usually mixed with a fugitive binder such as methylcellulose or other very low char yield organic materials to hold the compact together prior to sintering. The binder has no function in the final part and is “burned out” during the sintering process that makes the dense ceramic component. However, the binder burnout process is time consuming and can lead to cracking of thicker parts. In addition, the binders can leave residual contaminants in the ceramic that will as a minimum render the final ceramic impure, and may interfere with densification, leading to pores and weak areas in the final part. Finally, since the binder is removed prior to the onset of sintering, only the mechanical locking of the powder particles maintains the integrity of the component. Large or complex components cannot be made reliably due to the loss of strength after binder burn-out.

The invention provides a solution to the above issues by replacing the fugitive binder with a high purity, high ceramic yield, tailored viscosity polymer that is not burned out, but bonds the powder particles together such that there is no loss in strength and less shrinkage during the sintering stage.

### SUMMARY OF THE INVENTION

The invention is the use of ceramic forming polymers to provide non-fugitive, high purity binders for densifying and sintering ceramic materials. The polymers have a backbone of silicon linked to carbon with primarily hydrogen side-groups. The advantages of the invention include dramatically strengthening the component during the pre-sintering heating. Elimination of the time-consuming binder burn-out step and the associated residual contaminants from the binder. Elimination of cracking of thick-section parts due to non-uniform binder burn-out. Decreasing the shrinkage during densification and sintering since the high ceramic yield polymers occupy much of the space between the powder particles. It is expected that the use of the invention will decrease both the production cost and energy usage required to manufacture silicon carbide and silicon carbide bonded ceramics and composites.

### DESCRIPTION OF THE INVENTION

The gist of the invention is using high ceramic yield, high purity SiC forming liquid polymers to replace, and function as both binders and densification/sintering aids. The polymers cure at low temperatures to make a “green” machinable component. The component can be rapidly machined using conventional tooling to very complex shapes. The cured component loses only a small amount of its “green strength” during subsequent pyrolysis of the ceramic forming polymer (firing) and the shrinkage will be only about 1 to 3% when fired up to 1200° C. due to the high ceramic yield of the polymers. Further heating to 1800° C. to 2200° C. will produce a “sintered” part with near theoretical density.

A further aspect of the invention is the reduction or elimination of sintering aides due to the active nature (they contain one or more SiH, SiH₂ and/orSiH₃ groups) of the ceramic forming polymers. Another aspect of this invention is the addition of boron, aluminum, zirconium, hafnium, and or tantalum to the polymers to create polymers with those elements substituting for some or all of the silicon atoms in the polymer. In a typical case, 0.5-2% boron would be added to the polymer thus eliminating the need for the powder to be coated with binders and sintering aids by a separate mixing and spray drying step. In this way as-milled and dried ceramic powders can be used.

In a typical process the ceramic particles or powders are mixed with the ceramic forming polymer to form a molding compound, a clay, a slurry or a paint depending on the application. The molding compound or clay would be molded or pressed into a mold, while the slurries or paint would be applied by painting, spraying or dipping. The molded or coated parts would be cured by heating in inert gas such as nitrogen, argon, or helium at a rate depending on part thickness of from 0.1 degrees per minute up to 3 degrees per minute to a curing temperature of 250° C. to 450° C. and held for 1-6 hours. The cured component is strong enough to be handled and “green” machined to near net shape or close to net shape if extruded or injection molded. The part would then be “fired” under inert gas at a heating rate of 1 degree per minute up to 3 degrees per minute to 900° C. and held for 1 hour. The part can be removed from the furnace and used, or alternatively, it can be further heated at 2 degrees C. per minute under inert gas (argon or helium only if heated to over 1400° C.) to between 1400° C. and 2400° C. to further densify and sinter the component.

In many cases a near-net shape molded part can be “direct fired” in argon or helium from room temperature through the densification or sintering temperature after the molding step. Due to the high ceramic yield of the ceramic forming polymers, parts made using the invention would exhibit lower and more controlled shrinkage upon firing and sintering than components made by prior art processes.

Silicon carbide is an advanced ceramic material which is useful as electronic materials, as materials replacements for metals in engines, and for other applications where high strength, combined with resistance to oxidation, corrosion, and thermal degradation at temperatures in excess of 10000 C., are required. Unfortunately, these extremely hard, non-melting ceramics are difficult to process by conventional forming, machining, or spinning applications rendering their use for many of these important applications difficult or impossible due to poor final product properties. In particular, the production of thin films by solution casting, continuous fiber by solution or melt spinning, a silicon carbide matrix composite by liquid phase infiltration, or a monolithic object using a precursor-based binder/powder/sintering aid mixture, all require a silicon carbide which is suitable for solution or melt processing and which possesses certain requisite physical and chemical properties which are generally characteristic of polymeric materials.

Polymeric precursors to ceramics such as silicon carbide afford a solution to this problem as they would allow conventional processing operations prior to conversion to ceramic. A ceramic precursor should be soluble in organic solvents, moldable or spinnable, crosslinkable, and give pure ceramic product in high yield on pyrolysis. Unfortunately, it is difficult to achieve all these goals simultaneously. Currently available silicon carbide precursor systems are lacking in one or more of these areas. Problems have been encountered in efforts to employ the existing polysilane and polycarbosilane precursors to Silicon carbide for preparation of Silicon carbide fiber and monolithic ceramic objects. All of these precursors have a carbon to silicon allylhydridopolycarboesilane ratios considerably greater than one, and undergo a complex series of ill-defined thermal decomposition reactions which generally lead to incorporation of excess carbon. The existence of even small amounts of carbon at the grain boundaries within silicon carbide ceramics has been found to have a detrimental effect on the strength of the ceramic, contributing to the relatively low room-temperature tensile strengths typically observed for precursor-derived Silicon carbide fibers.

The high purity ceramic forming polymers are used to improve densification of ceramic materials. One aspect of this invention is the use of high ceramic yield, hydrogen containing ceramic forming polymers as non-fugitive binders to improve densification of ceramic powders such as silicon carbide. A further benefit provided by the invention is the ability to tailor the composition of the polymers to control the properties of the ceramic product formed using the binder- powder mixture by optimizing densification.

The silicon carbide precursor polymers of this invention have utility as precursors to silicon carbide ceramics. These compositions are obtained by a Grignard coupling process starting from chlorocarbosilanes, a readily available class of compounds. The new precursors constitute a class of polycarbosilanes that is characterized by a branched, Si—C backbone comprised of SiR₃CH₂—, —SiR₂CH˜—, ═SiRCH₂—, and≡SiCH₂— units where R is usually H but can also be other organic or inorganic groups. e.g., lower alkyl or alkenyl,

as may be needed to promote cross linking or to modify the physical properties of the polymer or the composition and properties of the final ceramic product. A key feature of these polymers is that substantially all of the linkages between the Si—C units are “head-to-tail”, i.e., they are Si to C. Carbosilane polymer precursors to silicon carbide are described in U.S. Pat. No. 5,153,295 which is incorporated herein by reference

In one embodiment of the invention the polymeric silicon carbide precursor is polycarbosilane SiH₂CH₂ which has a carbon to silicon ratio of I to I and where substantially all of the substituents on the polymer backbone are hydrogen. This polymer consists largely of a combination of the four polymer units: S1H₃CH₂—, —SiH₂CH₂—, ═SiHCH₂—, and —S1CH₂— which are connected head-to-tail in such a manner that a complex, branched structure results The branched sites introduced by the last two units are offset by a corresponding number of SiH3C—H₂— end groups while maintaining the alternating Si—C backbone. The relative numbers of the polymer units are such that the average formula is SiH₂CH₂. These polymers have the advantage that it is only necessary to lose hydrogen during pyrolysis, thus ceramic yields of over 90% are possible, in principle. The extensive Si—H functionality allows facile cross-linking and the 1 to 1 carbon to silicon ratio and avoids incorporation of excess carbon in the Silicon carbide products.

An advantage of these precursors is that the synthetic procedure employed to make them allows facile modification of the polymer, such as by introduction of small amounts of pendant vinyl groups, prior to reduction. The resulting vinyl-substituted SiH₂CH₂ polymer has been found to have improved crosslinking properties and higher ceramic yield. The above described polymer precursors can be used as binders, densification enhancement aids, and sintering aids for ceramic powders, whiskers, and fibers. The ceramic forming polymers can be used as the vehicle for holding fine ceramic carbide powders in a liquid suspension for coating large particulates in order to bond the large particulates together into a component. They are useful as a vehicle for holding fine ceramic carbide powders such as silicon carbide in a liquid suspension for coating large particulates in order to bond the large particulates together into a component. Such a suspension can be used for coating fibers, assisting in the densification of ceramic fiber based composites, woven ceramic structures, and carbon fiber structures. The compositions of the invention are used as binders, densification enhancement aids, and sintering aids for ceramic powders, ceramic or carbon whiskers, and fibers structures such as felts, woven cloth, or three dimensional structures.

The ceramic forming polymers useful in the practice of the invention include polycarbosilanes, hydridopolycarbosilanes such as allylhydridopolycarboesilane, polyhydridosilanes, and polyhyridosilazanes, optionally in admixture with from about 0.25% to about 5% by weight boron added. Generally, the polymer content of the starting composition can be from about 5% to about 50% polymer by mass with the preferred ratio being from about 20% to about 35%. The amount of powder is selected to provide the proper consistency of the composition for the coating technique to be used. Suitable ceramic powders include silicon carbide, silicon nitride, silicon dioxide, and the carbides, nitrides, and oxides of aluminum, titanium, molybdenum, tungsten, hafnium, zirconium, niobium, chromium and tantalum, individually or mixtures thereof. Powder size for fine powders, as defined herein, can range from about 10 nanometers to about 7 micrometers with the preferred range being about 0.4 micrometers to about 1.5 micrometers. As used herein, the term fine powder refers to such powder.

The ceramic forming polycarbosilanes, hydridopolycarbosilanes, polyhydridosilanes, polyhyridosilazanes polymers, with or without added boron, can be used as a vehicle to hold fine ceramic carbide powders in a liquid suspension. This suspension can be used for coating larger size powders or other particulates to bond the large powders or particulates together into a near shape form or component part.

The polymer content of the vehicle composition for this embodiment of the invention can be from about 35% to about 100% polymer by mass with the preferred ratio being about 50% to 85% and the large particulates can be from about 10 microns to about 1 millimeter.

The ceramic forming polymers described herein can be used as the vehicle or suspension medium to hold fine ceramic powders in a liquid suspension for coating carbon or ceramic fibers and assisting in the densification of ceramic fiber reinforced composites and for infiltrating woven or pressed ceramic and carbon fiber structures. Generally, the vehicle for coating and infiltration comprises from about 35% to about 100% polymer by mass with the preferred ratio from about 50% to 85% polymer by mass.

The fine powder suspension compositions of ceramic forming polymers as herein described can be used as a vehicle to hold fine ceramic carbide powders in a liquid suspension for sealing or coating porous ceramic and metal materials and shapes. Illustrative sealing and coating compositions generally comprise from about 35% to about 100% polymer by mass. A preferred range is from about 75% to about 85% polymer by mass.

Embodiments of this invention include compositions and methods for using ceramic forming polymers as binders, densification enhancement aids, and sintering aids for article or component preforms comprising ceramic powders, whiskers, and ceramic or carbon fibers or fiber multi-dimensional structures.

Generally, the polymer content of the starting composition for coating and preform infiltration can be from about 5% to about 50% polymer by mass. preferred ratio is from about 20% to about 35% polymer by mass.

The ceramic forming polymers described herein can be used as the vehicle to hold fine ceramic carbide powders in a liquid suspension for coating fibers and assisting in the densification of ceramic fiber based composites and woven ceramic and carbon fiber structures. Generally, the vehicle comprises from about 35% to about 100% polymer by mass with the preferred ratio from about 50% to 85% polymer by mass.

The polycarbosilanes, hydridopolycarbosilanes, polyhydridosilanes, polyhyridosilazanes, vehicle compositions can contain from about 0.25% to about 5% by weight of added boron, powders selected from the group consisting of silicon carbide, silicon nitride, silicon dioxide, and/or the carbides, nitrides, and oxides of the following: aluminum, titanium, molybdenum, tungsten, hafnium, zirconium, niobium, chromium and tantalum over the size range from about 10 nanometers up to about 7 micrometers with the preferred range being about 0.4 micrometers to about 1.5 micrometers.

The compositions of the are useful for sealing and coating porous ceramic and metal materials and shapes. Illustrative sealing compositions comprise from about 35% to about 100% polymer by mass with the preferred range being from about 75% to about 85%.

In an embodiment of the invention 100 grams of silicon carbide powder (0.5 micron) is mixed with 25 grams of silicon carbide forming polymer to form a clay-like material. The material is pressed into a mold to form the desired shape. The shape is then be cured by heating at a rate of between 1 degree and 5 degrees per minute with the preferred rate of 2 degrees per minute to between 200° C. and 450° C., with a hold time at maximum temperature from 5 minutes to 8 hours with the preferred time of 2 hours. The component would then be machined to the desired shape and fired at a rate of between 0.5° C. per minute and 5° C. per minute with the preferred rate of 2 degrees per minute, to a maximum temperature ranging from 800° C. to 2200° C. depending on the desired density. This experiment was repeated with 0.4, 0.8, and 1.2 micron powders.

In another embodiment of the invention, 100 grams of silicon carbide powder (0.5 micron) is mixed with 50-100 grams of silicon carbide forming polymer to form a paint-like slurry. The slurry is then mixed with between 300 grams and 1000 grams of ceramic particulates, such that the particulates are thoroughly coated with the slurry. The mixture is then pressed into a mold to form the desired shape. The shape would then be cured by heating at a rate of between 1 degree and 5 degrees per minute with the preferred rate of 2 degrees per minute to between 200° C. and 450° C., with a hold time at maximum temperature from 5 minutes to 8 hours with the preferred time of 2 hours. The component would then be machined to the desired shape and fired at a rate of between 0.5° C. per minute and 5° C. per minute with the preferred rate of 2 degrees per minute, to a maximum temperature ranging from 800° C. to 2200° C. depending on the desired density.

In another embodiment of the invention, 100 grams of silicon carbide powder (0.5 micron) is mixed with 50-100 grams of silicon carbide forming polymer such as allylhydridopolycarboesilane, available from Starfire Systems of Watervliet, N.Y., to form a paint-like slurry. The slurry is then applied to ceramic fibers, carbon fibers, or cloth made if ceramic fibers or carbon fibers by spraying, dipping, slurry coating, or brushing. The coated fibers and/or cloth are then assembled into a preform or component by being held in a suitable mold or fixture. The component in the mold or fixture would then be cured by heating at a rate of between 1 degree and 5 degrees per minute with the preferred rate of 2 degrees per minute to between 200° C. and 450° C., with a hold time at maximum temperature from 5 minutes to 8 hours with the preferred time of 2 hours. The component would then be removed from the mold/fixture and machined to the desired shape. Subsequently, the part would be fired at a rate of between 0.5° C. per minute and 5° C. per minute with the preferred rate of 2 degrees per minute, to a maximum temperature ranging from 800° C. to 1700° C. depending on the desired density and type of fiber.

The invention contemplates multiple embodiments involving the use of high purity silicon carbide forming polymers for enhancement of densification, joining, and sealing of ceramic materials and ceramic composites.

The polymers are used as binders, densification enhancement aids, and sintering aids for ceramic powders, whiskers, and fibers. The polymers are used as the vehicle to hold fine ceramic carbide powders in a liquid suspension for coating large particulates in order to bond the large particulates together into a component. As used herein the term large particle refers to particles of about 10 micrometers to about 1 millimeter in size. The polymers are used as the vehicle to hold fine ceramic carbide powders in a liquid suspension for coating fibers and assisting in the densification of ceramic fiber based composites and woven ceramic and carbon fiber structures. The polymers are used as the vehicle to hold fine ceramic carbide powders in a liquid suspension for joining, sealing, or coating porous and nonporous ceramic and metal materials. The polymers are used with ceramic powders, whiskers, chopped fiber, continuous fiber, platelets, felts, or papers to produce materials or components that have a nominal pore size of between 0.1 nanometers and 50 nanometers.

The following examples illustrate the practice of this invention.

### EXAMPLE 1

One hundred grams of 0.8 micron silicon carbide powder is mixed with 25 grams of silicon carbide forming polymer, allylhydridopolycarboesilane, to form a clay-like material. The material is pressed into a mold to form the desired shape. The shape is then cured by heating at a rate of between 0.1 degree and 5 degrees per minute with the preferred rate of 1 degree per minute to between 200° C. and 450° C., with a hold time at maximum temperature from 5 minutes to 8 hours with the preferred time of 2 hours. The component is then machined to the desired shape and fired at a rate of between 0.5° C. per minute and 5° C., per minute with the preferred rate of 2 degrees per minute, to a maximum temperature ranging from 800° C. to 2200° C. depending on the desired density.

### EXAMPLE 2

Seventy grams of 240 mesh silicon carbide powder, 45 grams of 500 mesh silicon carbide powder, 25 grams of 0.8 micron silicon carbide powder are thoroughly mixed with 14 grams of silicon carbide forming polymer, allylhydridopolycarboesilane, to make a molding compound mixture. The material is pressed into a ring mold to form a collar for ceramic or ceramic composite heat exchanger or radiant burner tubing. The ring would then be cured by heating at a rate of between 1 degree and 5 degrees per minute with the preferred rate of 1 degree per minute to between 200° C. and 450° C., with a hold time at maximum temperature from 5 minutes to 8 hours with the preferred time of 2 hours. The component is then machined to the desired shape and fired at a rate of between 0.5° C. per minute and 5° C. per minute with the preferred rate of 2 degrees per minute, to a maximum temperature ranging from 800° C. to 2200° C. depending on the desired density.

### EXAMPLE 3

Eighty five grams of 0.8 mesh boron carbide powder is mixed thoroughly with 15 grams of silicon carbide forming polymer, allylhydridopolycarboesilane. The mixture is pressed into a 3″×3″ mold to make a ceramic plate or tile using 4,000 to 30,000 psi of pressure with the preferred pressure of 8,000 to 10,000 psi. The plate is then cured by heating at a rate of between 0.1 degree and 5 degrees per minute with the preferred rate of 0.5-1 degree per minute to between 200° C. and 450° C., with a hold time at maximum temperature from 5 minutes to 8 hours with the preferred time of 2 hours. The component is then machined to the desired shape and fired at a rate of between 0.5° C. per minute and 5° C. per minute with the preferred rate of 2 degrees per minute, to a maximum temperature ranging from 1000° C. to 2400° C. depending on the desired density.

### EXAMPLE 4

One hundred grams of 0.8 micron silicon carbide powder is mixed with 50 to 100 grams of silicon carbide forming polymer, allylhydridopolycarboesilane, to form a paint-like slurry. The slurry is then mixed with between 300 grams and 1000 grams of ceramic particulates, such that the particulates are thoroughly coated with the slurry. The mixture is then pressed into a mold to form the desired shape. The shape is then cured by heating at a rate of between 1 degree and 5 degrees per minute with the preferred rate of 2 degrees per minute to between 200° C. and 450° C., with a hold time at maximum temperature from 5 minutes to 8 hours with the preferred time of 2 hours. The component is then machined to the desired shape and fired at a rate of between 0.5° C. per minute and 5° C. per minute with the preferred rate of 2 degrees per minute, to a maximum temperature ranging from 800° C. to 2200° C. depending on the desired density.

### EXAMPLE 5

One hundred grams of 0.8 micron boron carbide powder is mixed with 50-100 grams of silicon carbide forming polymer, allylhydridopolycarboesilane, to form a paint-like slurry. The slurry is then mixed with between 300 grams and 1000 grams of ceramic particulates such as 150 mesh silicon carbide, to thoroughly coat the particles with the slurry. The mixture is then pressed into a mold to form the desired shape. The shape is then cured by heating at a rate of between 1 degree and 5 degrees per minute with the preferred rate of 2 degrees per minute to between 200° C. and 450° C., with a hold time at maximum temperature from 5 minutes to 8 hours with the preferred time of 2 hours. The component is then machined to the desired shape and fired at a rate of between 0.5° C. per minute and 5° C. per minute with the preferred rate of 2 degrees per minute, to a maximum temperature ranging from 800° C. to 2400° C. depending on the desired density.

### EXAMPLE 6

One hundred grams of 0.8 micron silicon carbide powder is mixed with 50-100 grams of silicon carbide forming polymer, allylhydridopolycarboesilane, to form a paint-like slurry. The slurry is then mixed with between 300 grams and 1000 grams of ceramic or carbon coated uranium oxide/uranium carbide particulate such as “TRISO”, “BISO, or “Modified TRISO” nuclear fuel particles, such that the particles are thoroughly coated with the slurry. The mixture is then pressed into a mold to form a spherical ball roughly the size of a pool ball (2″ to 3″ in diameter). The sphere is then be cured by heating at a rate of between 0.1 degree and 5 degrees per minute with the preferred rate of 0.5-1 degree per minute to between 200° C. and 450° C., with a hold time at maximum temperature from 5 minutes to 8 hours with the preferred time of 2 hours. The component is then machined to the desired shape and fired at a rate of between 0.5° C. per minute and 5° C. per minute with the preferred rate of 2 degrees per minute, to a maximum temperature ranging from 800° C. to 1800° C. depending on the desired density.

### EXAMPLE 7

One hundred grams of silicon carbide powder is mixed with 50-100 grams of silicon carbide forming polymer, allylhydridopolycarboesilane, to form a paint-like slurry. The slurry is then applied to ceramic fibers, carbon fibers, or cloth made of ceramic fibers or carbon fibers by spraying, dipping, slurry coating, or brushing. The coated fibers and/or cloth are then assembled into a preform or component by being held in some form of mold or fixture. The component in the mold or fixture is then cured by heating at a rate of between 1 degree and 5 degrees per minute with the preferred rate of 2 degrees per minute to between 200° C. and 450° C., with a hold time at maximum temperature from 5 minutes to 8 hours with the preferred time of 2 hours. The component is then removed from the mold and machined to the desired shape. Subsequently, the part is fired at a rate of between 0.5° C. per minute and 5° C. per minute with the preferred rate of 2 degrees per minute, to a maximum temperature ranging from 800° C. to 1700° C. depending on the desired density and type of fiber.

### EXAMPLE 8

Six grams of 500 mesh SiC powder, 4 grams of 0.8 micron silicon carbide powder, 0.9 grams of SiC whiskers, and 6 grams of silicon carbide forming polymer, allylhydridopolycarboesilane, are thoroughly mixed to form a “glue-like” mixture. The mixture is painted onto the joining surfaces of a ceramic ring/flange and a ceramic heat exchanger tube to function as the joint material. The material is also painted onto the ends and the inner diameter of a joining collar to join two ends of ceramic tubing together by “collar over a butt joint” method. The joined materials or part is then cured by heating at a rate of between 1 degree and 5 degrees per minute with the preferred rate of 2 degrees per minute to between 200° C. and 450° C., with a hold time at maximum temperature from 5 minutes to 8 hours with the preferred time of 2 hours. The component is then machined to the desired shape and fired at a rate of between 0.5° C. per minute and 5° C. per minute with the preferred rate of 2 degrees per minute, to a maximum temperature ranging from 800° C. to 2200° C. depending on the desired operating temperature.

### EXAMPLE 9

Six grams of 500 mesh silicon carbide powder, 4 grams of 0.8 micron SiC powder, and 8 grams of silicon carbide forming polymer, allylhydridopolycarboesilane, are thoroughly mixed to form a “paint-like” mixture. The mixture is painted onto the surface of a spherical ceramic ball such as one containing nuclear fuel particles described in a previous example to seal the surface region of the ball in order to contain fission or reaction products from any failed fuel particles. The coated spheres are then cured by heating at a rate of between 1 degree and 5 degrees per minute with the preferred rate of 2 degrees per minute to between 200° C. and 450° C., with a hold time at maximum temperature from 5 minutes to 8 hours with the preferred time of 2 hours. The component is then machined to the desired shape and fired at a rate of between 0.5° C. per minute and 5° C. per minute with the preferred rate of 2 degrees per minute, to a maximum temperature ranging from 800° C. to 1800° C. depending on the desired operating temperature.

What is claimed is:

1. Compositions for use as binders, densification enhancement aids, and sintering aids for ceramic powders, whiskers, and fibers comprising a silicon carbide forming polymer.

2. A composition according to claim 1 wherein the silicon carbide forming polymer is a polycarbosilanes, a polycarboborosilanes hydridopolycarbosilanes, a polyhydridosilanes, a polyhyridosilazanes, or a polyhydridosiloxanes with from about 0.25 to about 5 weight percent boron added, or another ceramic forming polymer that has one or more of the chemical groups SiH, SiH₂, or SiH₃ on the backbone, pendant structures, or branches and containing silicon, carbon, boron, oxygen, nitrogen, hafnium, or zirconium.

3. A composition according to claim 1 comprising the silicon carbide forming polymer and a ceramic powder selected from the group comprising silicon carbide, silicon nitride, silicon dioxide, and the carbides, nitrides, and oxides of aluminum, titanium, molybdenum, tungsten, hafnium, zirconium, niobium, chromium, iron, nickel, cobalt, tantalum, and mixtures thereof.

4. A composition according to claim 3 in which the powders range from about 10 nanometers up to about 7 micrometers.

5. A composition according to claim 3 in which the powders range from about 0.4 micrometers to about 1.5 micrometers.

6. A composition according to claim 2 in which the polymer comprises from about 5% to about 50% by mass of the composition.

7. A composition according to claim 2 in which the polymer comprises from about 10% to about 20% by mass of the composition.

8. A composition for coating large particulates in order to bond the large particulates together into a component comprising a silicon carbide forming polymer as the vehicle to hold fine ceramic carbide powders in a liquid suspension.

9. A composition according to claim 8 wherein the carbide forming polymer is a polycarbosilanes, a polycarboborosilanes hydridopolycarbosilanes, a polyhydridosilanes, a polyhyridosilazanes, or a polyhydridosiloxanes with from about 0.25 to about 5 weight percent boron added, or another ceramic forming polymer that has one or more of the chemical groups SiH, SiH₂, or SiH₃ on the backbone, pendant structures, or branches and containing silicon, carbon, boron, oxygen, nitrogen, hafnium, or zirconium.

10. A composition according to claim 8 in which the powders are silicon carbide, silicon nitride, silicon dioxide, or carbides, nitrides, and oxides of aluminum, titanium, molybdenum, tungsten, hafnium, zirconium, niobium, chromium, or tantalum being from about 10 nanometers up to about 7 micrometers in size.

11. A composition according to claim 10 in which the powder size is from about 0.4 micrometers to about 1.5 micrometers.

12. A composition according to claim 8 wherein the polymer comprises from about 35% to 100% by mass.

13. A composition according to claim 8 in which the large particulates are in the size range of about 10 micrometers to 1 about millimeter.

14. A Method for bonding, densifying, and sintering ceramic powders, particles, whiskers, and fibers which comprises providing a silicon carbide forming polymer and applying the polymer to said powders, particles, whiskers, and fibers.

15. A method according to claim 14 for making high density fiber containing ceramic bodies which comprises the use of ceramic forming polymers as a binder or vehicle to hold fine ceramic carbide powders in a liquid suspension for coating the fibers to enhance densification of ceramic and carbon fiber composites and structures.

16. A method according to claim 14 in which the polymers are polycarbosilanes, pqlycarboborosilanes hydridopolycarbosilanes, polyhydridosilanes, polyhyridosilazanes, or polyhydridosiloxanes, and any other ceramic forming polymers containing one or more of silicon, carbon, boron, oxygen, nitrogen, hafnium, zirconium or tantalum or the aforementioned polymers with from 0.25% to 5% by weight boron added that contain one or more of the following chemical groups on either the backbone or in pendant structures or branches: SiH, SiH₂, or SiH₃.

17. The use of polymers from claim 15 specifically with powders composed of a mixture of one or more of the following: silicon carbide, silicon nitride, silicon dioxide, and/or the carbides, nitrides, and oxides of the following: aluminum, titanium, molybdenum, tungsten, hafnium, zirconium, niobium, chromium and tantalum being in the size range from 10 nanometers up to 7 micrometers.

18. A process according to claim 14 for joining, sealing or coating porous and non-porous ceramic and metal materials which comprises using ceramic forming polymers as a vehicle for holding fine ceramic carbide powders in a liquid suspension and applying the suspension to said materials.

19. The process according to claim 14 which comprises using ceramic forming polymers with ceramic powders, whiskers, chopped fiber, continuous fiber, platelets, felts, or papers to produce materials or components that have a nominal pore size of between 0.1 nanometers and 50 nanometers.

20. The process according to claim 19 in which the polymer is polycarbosilanes, polycarboborosilanes, hydridopolycarbosilanes, polyhydridosilanes, polyhyridosilazanes, polyhydridosiloxanes, other ceramic forming polymers containing one or more of silicon, carbon, boron, oxygen, nitrogen, hafnium, zirconium or tantalum or the aforementioned polymers with from 0.25% to 5% by weight boron added that contain one or more of the following chemical groups on either the backbone or in pendant structures or branches: SiH, SiH₂, or SiH₃.
